(19) United States
(12) Patent Application Publication
(10) Pub. No.: US 2012/0327794 A1
(43) Pub. Date: Dec. 27, 2012

(54) METHOD AND APPARATUS FOR CONFIGURING TRANSMIT POWER OF RELAY NODE

(75) Inventors: Jungsoo HAN, Yongin-si (KR); Hyungjin CHOI, Seoul (KR); Youngil MIN, Suwon-si (KR); Junhee JANG, Seoul (KR); Jinho KIM, Seoul (KR); Junsung LIM, Seoul (KR)

(73) Assignees: SUNGKYUNKWAN UNIVERSITY Foundation for Corporate Collaboration, Suwon-si (KR); SAMSUNG ELECTRONICS CO. LTD., Suwon-si (KR)

(21) Appl. No.: 13/408,120

(22) Filed: Feb. 29, 2012

(30) Foreign Application Priority Data
Jun. 24, 2011 (KR) 10-2011-0061848

(51) Int. Cl. H04W 52/24; H04W 88/04; H04W 24/00

(52) U.S. Cl. 370/252

(57) ABSTRACT

A method and an apparatus for configuring transmit power of a relay node in consideration of a backhaul link channel state are provided. The method includes receiving a backhaul downlink signal, measuring a channel state of the backhaul downlink signal, and configuring access downlink transmit power using the measured channel state. The relay node transmit power control method of the present invention is advantageous in that a User Equipment (UE) can perform cell selection in consideration of the backhaul link channel state without extra signaling of the backhaul link channel state.

### PRIORITY

This application claims the benefit under 35 U.S.C. §119(a) of a Korean patent application filed on Jun. 24, 2011 in the Korean Intellectual Property Office and assigned Serial No. 10-2011-0061848, the entire disclosure of which is hereby incorporated by reference.

### JOINT RESEARCH AGREEMENT

The presently claimed invention was made by or on behalf of the below listed parties to a joint research agreement. The joint research agreement was in effect on or before the date the claimed invention was made and the claimed invention was made as a result of activities undertaken within the scope of the joint research agreement. The parties to the joint research agreement are 1) SAMSUNG ELECTRONICS CO., LTD., and 2) SUNGKYUNKWAN UNIVERSITY FOUNDATION FOR CORPORATE COLLABORATION.

### BACKGROUND OF THE INVENTION

1. Field of the Invention

The present invention relates to a transmit power configuration method and apparatus of a relay node in a mobile communication system. More particularly, the present invention relates to a method and apparatus for configuring transmit power of a relay node in consideration of a backhaul link channel state in a mobile communication system.

2. Description of the Related Art

The initial release of 3^{rd} Generation Partnership Project Long Term Evolution (3GPP LTE) has not supported relays. In this legacy LTE system, a User Equipment (UE) measures the strengths of all receivable Reference Signals (RSs) for selecting a serving cell. The UE selects the cell having the highest signal strength as the serving cell.

This cell selection process can be applied to the 3GPP LTE-Advanced (LTE-A) system supporting a type 1 relay. In this case, the UE measures the strengths of RSs transmitted by an enhanced Node B (eNB) and the type 1 relay and selects the cell having the highest received signal strength as the serving cell.

According to the cell selection method of the related art, the UE measures the received signal strengths of RSs on the access link between the type 1 relay and the UE and the direct link between the eNB and the UE. Suppose that the channel state (i.e., RS strength) of the direct link is worse than the channel state (i.e., RS strength) of the access link such that the type 1 relay is selected as the serving cell. In this situation, if the channel state of the backhaul link is bad, the UE's processing throughput is likely to become worse when the type 1 relay is selected as compared to the case when the eNB is selected.

In order to address this problem, the UE selects the serving cell in consideration of the channel state of the backhaul link. According to this method of the related art, one of the eNB and type 1 relay reports the channel information on the back channel to the UE such that the UE can select the serving cell in consideration of the channel state of the back channel. However, the method of the related art requires extra signaling (i.e., channel state of backhaul link) and provides no solution for suppressing the interference caused by the type 1 relay. There is therefore a need of a cell selection method that is capable of performing a cell selection process without extra signaling of the backhaul channel state information and mitigating interference caused by the relay node.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a transmit power configuration method and apparatus of a relay that is capable of selecting the serving cell in consideration of the channel state of the backhaul link without reporting the channel state of the backhaul link to the User Equipment (UE).

Another aspect of the present invention is to provide a transmit power configuration method and apparatus of a relay that is capable of mitigating the interference caused by the relay.

In accordance with an aspect of the present invention, a transmit power configuration method of a relay node in a mobile communication system is provided. The method includes receiving a backhaul downlink signal, measuring a channel state of the backhaul downlink signal, and configuring access downlink transmit power using the measured channel state.

In accordance with another aspect of the present invention, a relay node of a mobile communication system is provided. The relay node includes a radio frequency unit which receives a backhaul downlink signal, a backhaul link channel determiner which measures channel state of the backhaul downlink signal, and a transmit power configurator which configures access downlink transmit power using the measured channel state.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating cell selection of a User Equipment (UE) in a method according to the related art;

FIG. 2 is a graph illustrating a Signal-to-Interference-plus-Noise Ratio (SINR) Cumulative Distribution Function (CDF) with and without consideration of a channel state of a backhaul link in a serving cell selection process according to the related art;

FIG. 3 is a diagram illustrating a transmit power configuration method of a relay node in a mobile communication system according to an exemplary embodiment of the present invention;

FIG. 4 is a block diagram illustrating a configuration of a relay node according to an exemplary embodiment of the present invention;

FIG. 5 is a flowchart illustrating a transmit power configuration method of a relay node according to an exemplary embodiment of the present invention; and

FIG. 6 is a graph illustrating SINR CDF comparison among serving cell selection methods of a UE.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Descriptions are made of transmit power configuration methods and apparatuses of a relay node according to exemplary embodiments of the present invention with reference to accompanying drawings.

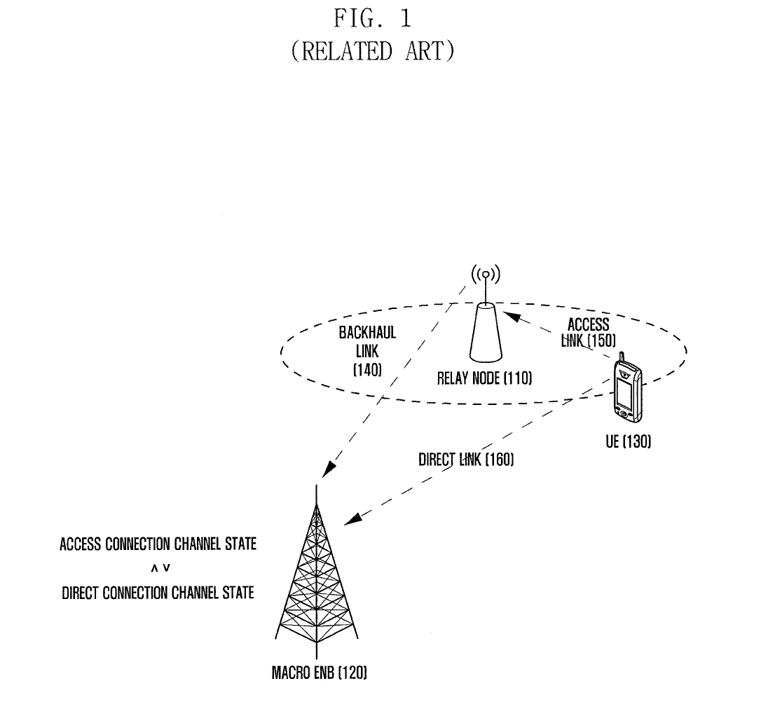

FIG. 1 is a diagram illustrating cell selection of a User Equipment (UE) in a method according to the related art.

Referring to FIG. 1, the mobile communication system includes a relay node 110, a macro evolved Node B (eNB) 120, and a UE 130. FIG. 1 is directed to a 3^{rd} Generation Partnership Project Long Term Evolution (3GPP LTE-A) system including type 1 relays.

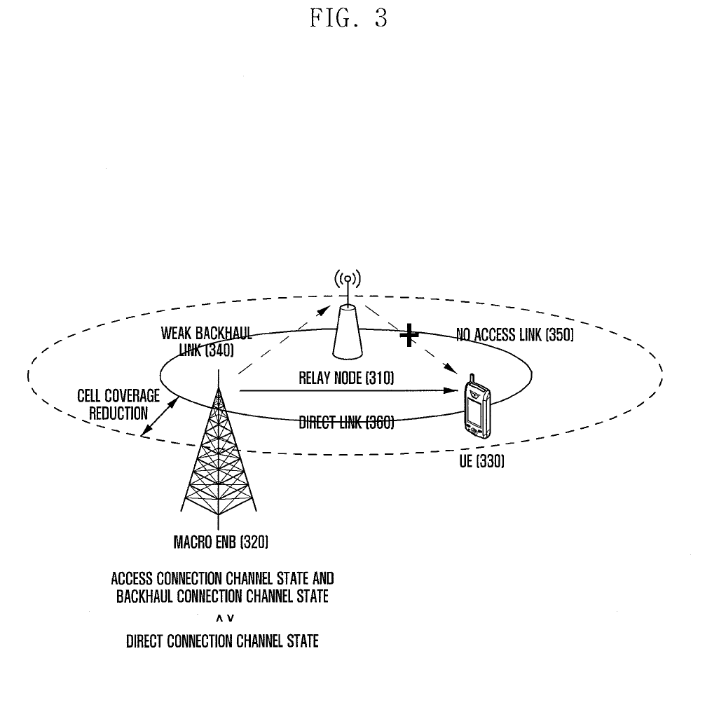

The relay node 110 relays communication between the macro eNB 120 and the UE 130. The relay node 110 also operates as the eNB in view of the UE 130. In FIGS. 1 and 3, the relay node 110 relays communication between the macro eNB 120 and the UE 130. According to a modified exemplary embodiment, the relay node 110 can relay communication between a femto base station or another type of eNB or base station, instead of the macro eNB 120, and the UE 130. In the following, the description is directed to an exemplary case where the relay node relays communication between a macro eNB and a UE.

The macro eNB 120 and the relay node 110 are connected through backhaul link 140. The relay node 110 and the UE are connected through an access link 150. The macro eNB 120 and the UE 130 are connected through a direct link 160.

The UE 130 perceives the relay node 110 as an eNB. The relay node 110 operates as an independent cell in association with the UE 130. Accordingly, the macro eNB 120 and the relay node 110 transmit respective Reference Signals (RSs) to the UE 130. In the method of the related art, the UE 130 selects the serving cell based on the strength of RS or channel state. That is, the UE 130 selects the serving cell by taking only the channel states of the access and direct links into account. Suppose that the channel state of the access link 130 is better than that of the direct link 160 such that the relay node 110 is selected as the serving cell according to the method of the related art. However, if the channel state of the backhaul link 140 is very bad, the actual processing throughput of the UE 130 degrades. That is, if the channel state of the back link 140 is very bad, the UE 130 may prefer to select the macro eNB 120 as the serving cell instead of the relay node 110. In the method of the related art, however the UE 130 selects the relay node 110 as the serving cell, resulting in a failure of best cell selection.

A method of the related art to address this problem is for the UE 130 to select the serving cell in consideration of the channel state of the backhaul link 140. When selecting the serving cell, the UE 130 can take the channel states of both the backhaul link 140 and the access link 150 into consideration. The UE 139 can acquire the channel state of each link in the form of Signal-to-Interference-plus-Noise Ratio (SINR). The UE can calculate the actual signal SINR of the access link 140 (SINR_{eNB-RN-UE}) by taking both the SINRs of the backhaul link 140 and the access link into account, using equation (1):

$${SINR}_{eNB - RN - UE} = {f}^{- 1} \{ \frac{1}{\frac{1}{f ( {SINR}_{access \_ link} )} + \frac{1}{f ( {SINR}_{backhaul \_ link} )}} \} \qquad ( 1 )$$

where SINR_{eNB-RN-UE} denotes the SINR obtained by taking the channel states of both the backhaul link 140 and access link 150. SINR_{access}_{_{—}}ₗᵢₙₖ denotes the SINR of the access link 150. SINR_{backhaul}_{_{—}}ₗᵢₙₖ denotes the SINR of the backhaul link 140. f(x) denotes the Shannon capacity function, and f¹(x) denotes the reversed function of the Shannon capacity function. The Shannon capacity function and its reversed function can be expressed as equations (2):

f(x)=log₂(x−1),

f¹(x)=2^{x}−1 (2)

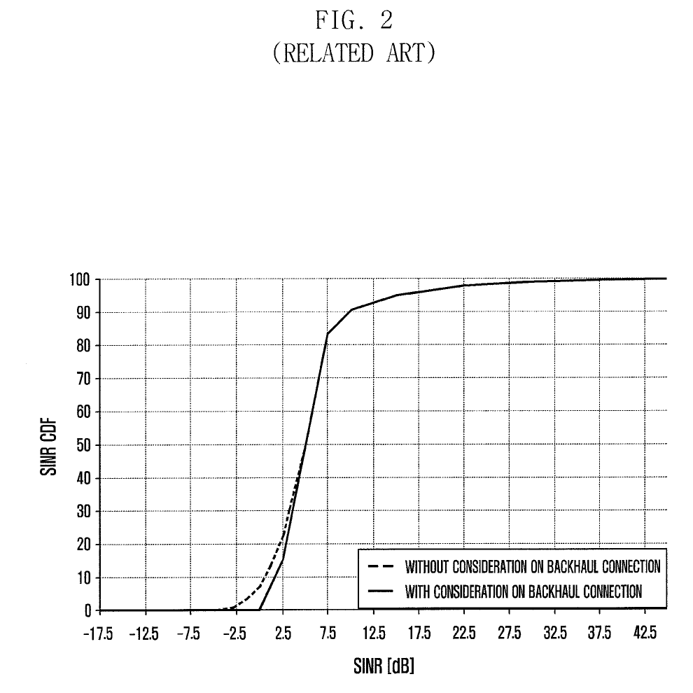

FIG. 2 is a graph illustrating SINR Cumulative Distribution Function (CDF) with and without consideration of a channel state of a backhaul link in serving cell selection process according to the related art. In the graph of FIG. 2, the vertical axis denotes SINR CDF, and the horizontal axis denotes the actual SINR of the link with the selected cell.

Referring to FIG. 2, the graph shows that the serving cell selection with consideration of the backhaul link 140 is superior to the serving cell selection without consideration of the backhaul link 140 in terms of SINR. The difference between the two methods takes place when the SINR of the direct link 160 is worse than SINR_{access}_{_{—}}ₗᵢₙₖ but better than SINR_{enb-RN-UE}. In this case, according to the cell selection method without consideration of the backhaul link 140, the UE 130 selects the relay node 110 as the serving cell. In contrast, according to the cell selection method with consideration of the backhaul link 140, the UE 130 selects the macro eNB 120 as the serving cell. Although there is no such difference in the range of high SINR, the difference of the SINR CDF takes place in the range of low SINR.

In order for the UE to select the serving cell in consideration of the backhaul link 140, the information on the channel state of the backhaul link 140 should be known. For this purpose, the macro eNB 120 or the relay node 10 can notify the UE 130 of the channel state of the backhaul link 140.

Although the best cell selection failure problem can be addressed by taking the backhaul link channel state into account, this causes another problem of extra traffic for notifying the UE 130 of the channel state of the backhaul link 140. Also, although the macro eNB 120 is selected as the serving cell in consideration of the backhaul link 140, if the signal strength of the relay node 110 is strong and the signal strength of the macro eNB 120 is weak, the signal of the relay node causes interference to the signal of the macro eNB 120.

FIG. 3 is a diagram illustrating a transmit power configuration method of a relay node in a mobile communication system according to an exemplary embodiment of the present invention.

Referring to FIG. 3, the mobile communication system includes a relay node 310, a macro eNB 320, and a UE 330. Here, the macro eNB 320 and the relay node 310 operate as a base station. However, the relay node 310 is also responsible for relaying communication between the macro eNB 320 and the UE 330. As aforementioned, the term ‘macro eNB’ is used for discriminating between the roles of the macro eNB 320 and relay node 310. Although the description is directed to the case where the relay node 310 is the type 1 relay, the present invention can be applied to the system including multi-hop relay or other type of relay. In this case, the reference for the transmit power configuration of the relay node 310 is the channel state of the backhaul link between the relay node 310 and other relay node or other eNB other than the macro eNB 320.

In the exemplary embodiment of FIG. 3, it is assumed that the channel state of the backhaul link 340 between the macro eNB 320 and the relay node 310 is relatively bad. According to the method of the related art, the channel state of the backhaul link is reported to the UE 330 such that the UE 330 selects the serving cell based on the channel state of the backhaul link 340. However, according to an exemplary embodiment of the present invention, there is no need for the backhaul link channel state report to be provided to the UE 330 and no need for the consideration on the channel state of the backhaul link 340 in cell selection process. Instead, the transmit power of the relay node 310 is adjusted.

The relay node 310 receives the backhaul downlink signal. The relay node 310 measures the channel state based on the received downlink signal. The relay node 310 adjusts the transmit power based on the measured channel state. It has been assumed that the channel state of the backhaul link 340 between macro eNB 320 and the relay node 310 is bad. Accordingly, the relay node reduces the transmit power. Since the channel state of the backhaul link 340 is bad, the UE 330 is guided not to select the relay node 310 as the serving cell. This also prevents the transmission signal of the relay node 310 from causing interference to the UE 330.

If the transmit power is reduced, the cell coverage of the relay node 310 decreases. Accordingly, the UE 330 located far from the relay node does not select the access link 350 with the relay node 310 but the direct link 360 to communicate with the macro eNB 320. In this manner, the UE 330 can select the cell that is capable of optimizing the processing throughput of the UE 330. Also, since the UE 330 goes out of the coverage area of the relay node 310, it is possible to cancel the interference of the access link 350 to the direct link 360.

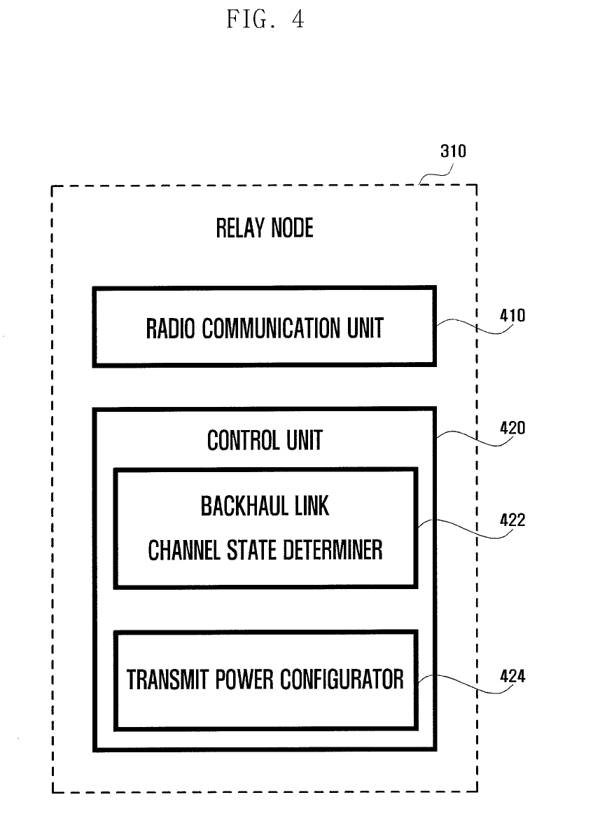

FIG. 4 is a block diagram illustrating a configuration of a relay node according to an exemplary embodiment of the present invention. The relay node 310 includes a Radio Frequency (RF) unit 410 and a control unit 420. The control unit 420 includes a backhaul link channel state determiner 422 and a transmit power configurator 424.

The RF unit 410 is responsible for radio communications with the macro eNB 320 and the UE 330. Particularly, the RF unit 410 can receive a backhaul downlink signal from the macro eNB 320. The RF unit 410 can deliver the backhaul downlink signal to the backhaul link channel state determiner 422. The RF unit 410 can adjust the transmit power of the downlink signal to the UE 330 according to the configuration of the transmit power configurator 424.

The control unit 420 controls overall operations of the relay node 310. Particularly in the LTE-A system, the control unit 420 of the relay node controls the RF unit 410 to use a specific resource for communication with the macro eNB 320 and the UE 330 according to the scheduling. The control unit 420 can encode the transmission packet and decode the received packet. The control unit 420 also can control other operations for radio communication.

The backhaul link channel state determiner 422 analyzes the backhaul downlink signal received by the RF unit 410 to determine the channel state of the backhaul downlink. The channel state of the backhaul downlink can be measured in the form of at least one of SINR, Signal-to-Noise Ratio (SNR), Signal-to-Interference Ratio (SIR), Carrier-to-Interference-plus-Noise Ratio (CINR), Carrier-to-Noise Ratio (CNR), Carrier-to-Interference Ratio (CIR), Received Signal Strength Indication (RSSI), etc. In the following, the description is directed to the case where the backhaul link channel state determiner 422 uses the SINR of the backhaul downlink signal for convenience in explanation. The backhaul link channel state determiner 422 measures SINR and transfers the measurement value to the transmit power configurator 424.

The transmit power configuration 424 receives the SINR from the backhaul link channel state determiner 422 and configures the transmit power based on the SINR. The higher the SINR is, i.e., the better the backhaul link channel state is, the greater the transmit power is.

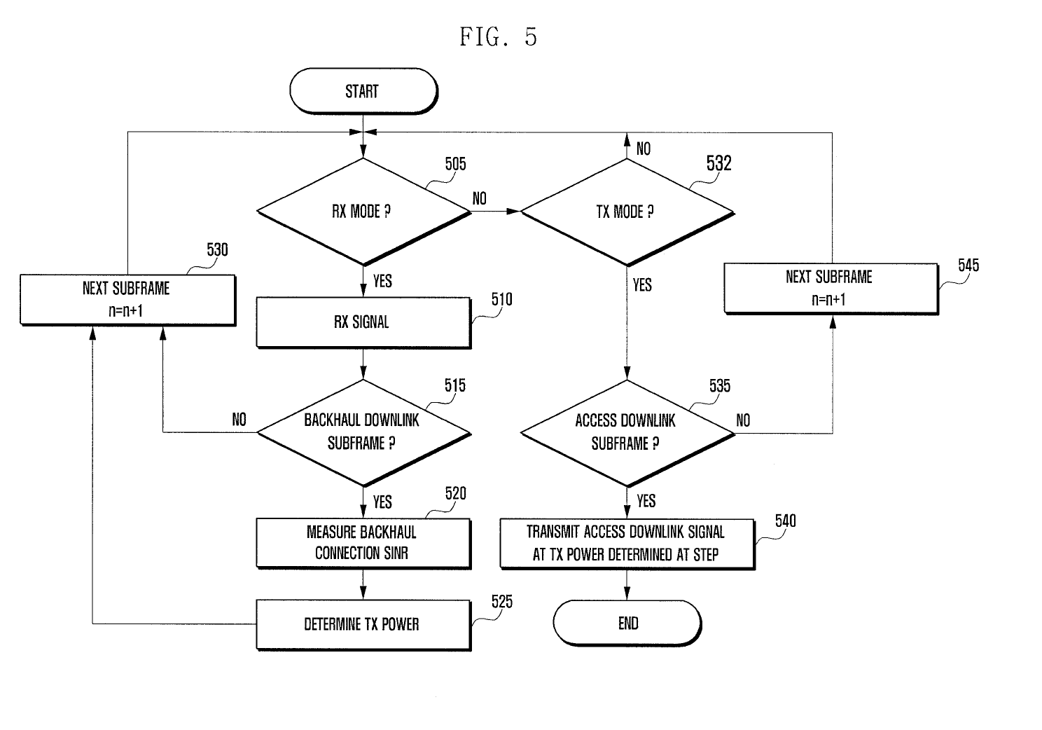

A description is made of the operations of the function blocks of the relay node hereinafter with reference to FIG. 5.

FIG. 5 is a flowchart illustrating a transmit power configuration method of a relay node according to an exemplary embodiment of the present invention.

The control unit 420 determines whether the relay node is in Reception (Rx) mode in step 505. If the relay node is not in the reception mode, the procedure proceeds to step 532. At step 532, the control unit 420 determines whether the relay node is in Transmission (Tx) mode. If the relay node is not in the transmission mode, the control unit 420 returns to step 505 so as to wait until the relay node enters the reception mode or the transmission mode. If the relay node 310 is in the transmission mode at step 532, the procedure proceeds to step 535. If the relay node is in the reception mode at step 505, the procedure proceeds to step 510. At step 510, the RF unit 410 receives a radio signal.

The control unit 420 determines whether a received subframe is a backhaul downlink subframe in step 515. If the received subframe is not the backhaul downlink subframe at step 515, this means that the received subframe is the access uplink subframe. The access uplink subframe is the subframe carrying the signal from the UE 330 to the relay node 310. If the received subframe is not the backhaul downlink subframe at step 515, this does not influence the method of the present exemplary embodiment such that the procedure proceeds to step 530 to receive the next subframe. Thereafter, the procedure returns to step 505. If the received subframe is the backhaul downlink subframe at step 515, the procedure proceeds to step 520. At step 520, the backhaul link state determiner 422 measures SINR of the backhaul downlink signal. The measurement result is delivered to the transmit power configurator 424.

At step 525, the transmit power configurator 424 configures the transmit power of the relay node 310 based on the SINR provided by the backhaul link state determiner 422. The transmit power configurator 424 can reduce the transmit power in proportion to a value obtained by subtracting the received SINR from the maximum SINR. The maximum SINR can be calculated using the condition in which the macro eNB 320 and the relay node 310 are distant from each other by over 35 m and a pathloss equation. According to another exemplary embodiment, the transmit power configurator 424 can increase the transmit power in proportion to the SINR provided by the backhaul link state determiner 422. The aforementioned transmit power adjustment scheme is just an example, and it is possible to apply another transmit power adjustment scheme using the relationship between the SINR and an amount of transmit power. Although the description is directed to the case where the SINR is used, the present invention can be implemented with a transmit power adjustment scheme using another parameter so as to increase the transmit power when the channel state of the backhaul link 340 is good.

According to an exemplary embodiment of the present invention, the transmit power configurator 424 can adjust only the downlink transmit power of the access link 350. This is because the UE 330 selects the serving cell according to the transmit power of the downlink connected to the UE 330. Also, this is because, when the UE 330 is connected to the macro eNB 320 directly, the main cause of the interference is the signal of the access link 350. According to another exemplary embodiment of the present invention, the transmit power configurator 424 can adjust the all of the transmit powers. Thereafter, the procedure proceeds to step 530.

If the relay node 310 is in the transmission mode at step 532, the procedure proceeds to step 535. At step 535, the control unit 420 determines whether the current subframe is an access downlink subframe. The access downlink subframe is the subframe carrying the signal from the relay node 310 to the UE 330. If the current subframe is not the access downlink subframe, this means that the current subframe is the backhaul uplink subframe. Since the uplink backhaul subframe is out of the range of the present invention, the procedure proceeds to step 545 to inspect the next subframe. Thereafter, the procedure returns to step 505. If the current frame is the access downlink subframe, the procedure proceeds to step 540. At step 540, the RF unit 410 transmits a signal. At this time, the signal is transmitted at the power determined at step 525.

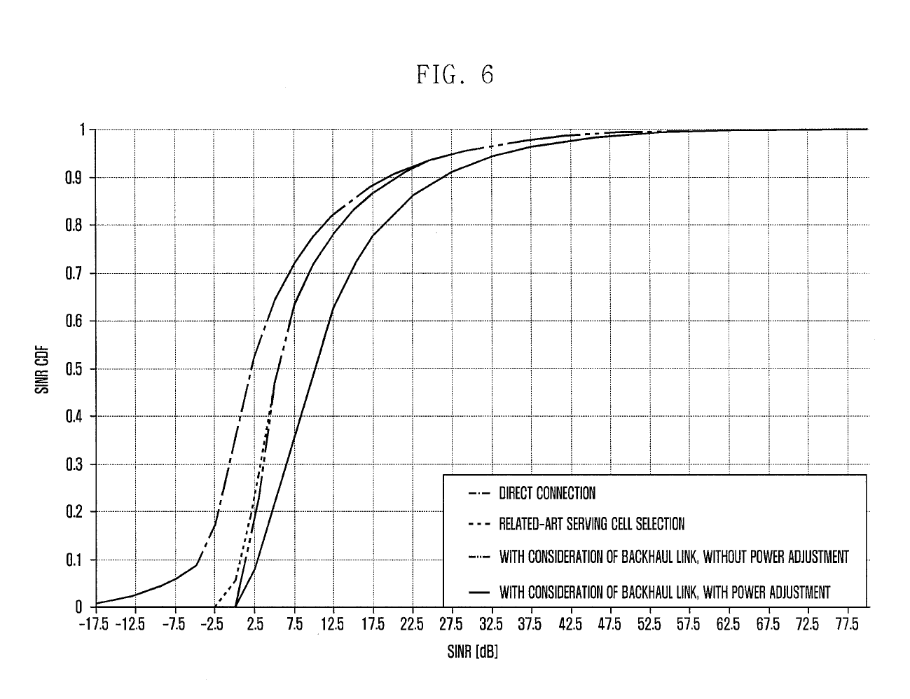

FIG. 6 is a graph illustrating SINR CDF comparison among serving cell selection methods of a UE. In FIG. 6, the horizontal axis denotes actual SINR in the connection to the serving cell selected by the UE. The vertical axis denotes SINR CDFs according to the serving cell selection methods applied by the UE.

Referring to FIG. 6, the graph shows that the method for adjusting the transmit power of the relay node in consideration of the SINR of the backhaul link is superior to other methods. The reason of this result is as follows. Assuming that the channel state of the backhaul link is bad, the transmit power of the relay node is reduced. As a consequence, the cell coverage of the relay node decreases. Accordingly, the UE selects the macro cell as the serving cell. Since the channel state of the backhaul link is bad, it is preferred to select the macro cell as the serving cell. With the reduction of transmit power of the relay node, the power of the interference signal caused by the relay node decreases such that the probability of high SINR at the UE increases. Accordingly, the SINR CDF difference takes place in the range of the high SINR range.

As described above, the relay node transmit power control method of exemplary embodiments of the present invention allows the UE to perform cell selection in consideration of the backhaul link channel state without extra signaling of backhaul link channel state and is capable of canceling the interference caused by the relay node.

It will be understood that each block of the flowchart illustrations and/or block diagrams, and combinations of blocks in the flowchart illustrations and/or block diagrams, can be implemented using computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Furthermore, the respective block diagrams may illustrate parts of modules, segments or codes including at least one or more executable instructions for performing specific logic function(s). Moreover, it should be noted that the functions of the blocks may be performed in different order in several modifications. For example, two successive blocks may be performed substantially at the same time, or may be performed in reverse order according to their functions.

The term “module” according to the exemplary embodiments of the invention, means, but is not limited to, a software or hardware component, such as a Field Programmable Gate Array (FPGA) or Application Specific Integrated Circuit (ASIC), which performs certain tasks. A module may advantageously be configured to reside on the addressable non-transitory storage medium and configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more Central Processing Units (CPUs) in a device or a secure multimedia card.

The foregoing disclosure has been set forth merely to illustrate the exemplary embodiments of the invention and is not intended to be limiting. Since modifications of the disclosed exemplary embodiments incorporating the spirit and substance of the invention may occur to persons skilled in the art, the invention should be construed to include everything within the scope of the appended claims and equivalents thereof.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A transmit power configuration method of a relay node in a mobile communication system, the method comprising:
receiving a backhaul downlink signal;
measuring a channel state of the backhaul downlink signal; and
configuring access downlink transmit power using the measured channel state.

2. The method of claim 1, wherein the configuring comprises setting the access downlink transmit power using a relationship between the measured channel state and an amount of the access downlink transmit power.

3. The method of claim 2, wherein the channel state comprises a Signal-to-Interference-plus-Noise Ratio (SINR) of the backhaul downlink signal.

4. The method of claim 3, wherein the configuring comprises increasing the access downlink transmit power in proportion to the measured SINR.

5. The method of claim 3, wherein the configuring comprises decreasing the access downlink transmit power in proportion to a value obtained by subtracting the measured SINR from a maximum SINR of the backhaul link.

6. The method of claim 2, wherein the channel state comprises at least one of a Signal-to-Noise Ratio (SNR) of the backhaul downlink signal, a Signal-to-Interference Ratio (SIR) of the backhaul downlink signal, a Carrier-to-Interference-plus-Noise Ratio (CINR) of the backhaul downlink signal, a Carrier-to-Noise Ratio (CNR) of the backhaul downlink signal, a Carrier-to-Interference Ratio (CIR) of the backhaul downlink signal, and a Received Signal Strength Indication (RSSI) of the backhaul downlink signal.

7. The method of claim 2, wherein the configuring comprises increasing the access downlink transmit power in proportion to the measured channel state.

8. The method of claim 2, wherein the configuring comprises decreasing the access downlink transmit power in proportion to a value obtained by subtracting the measured channel state from a maximum channel state of the backhaul link.

9. The method of claim 1, wherein the backhaul downlink signal comprises a backhaul downlink subframe, and
wherein the measuring of the channel state comprises measuring the channel state of the backhaul downlink subframe.

10. A relay node of a mobile communication system, the relay node comprising:
a radio frequency unit which receives a backhaul downlink signal;
a backhaul link channel determiner which measures a channel state of the backhaul downlink signal; and
a transmit power configurator which configures access downlink transmit power using the measured channel state.

11. The relay node of claim 10, wherein the transmit power configurator configures the access downlink transmit power using a relationship between the measured channel state and an amount of the access downlink transmit power.

12. The relay node of claim 11, wherein the channel state comprises a Signal-to-Interference-plus-Noise Ratio (SINR) of the backhaul downlink signal.

13. The relay node of claim 12, wherein the transmit power configurator increases the access downlink transmit power in proportion to the measured SINR.

14. The relay node of claim 12, wherein the transmit power configurator decreases the access downlink transmit power in proportion to a value obtained by subtracting the measured SINR from a maximum SINR of the backhaul link.

15. The relay node of claim 11, wherein the channel state comprises at least one of a Signal-to-Noise Ratio (SNR) of the backhaul downlink signal, a Signal-to-Interference Ratio (SIR) of the backhaul downlink signal, a Carrier-to-Interference-plus-Noise Ratio (CINR) of the backhaul downlink signal, a Carrier-to-Noise Ratio (CNR) of the backhaul downlink signal, a Carrier-to-Interference Ratio (CIR) of the backhaul downlink signal, and a Received Signal Strength Indication (RSSI) of the backhaul downlink signal.

16. The relay node of claim 11, wherein the transmit power configurator increases the access downlink transmit power in proportion to the measured channel state.

17. The relay node of claim 11, wherein the transmit power configurator decreases the access downlink transmit power in proportion to a value obtained by subtracting the measured channel state from a maximum channel state of the backhaul link.

18. The relay node of claim 10, wherein the backhaul downlink signal comprises a backhaul downlink subframe, and
wherein the backhaul link channel determiner measures the channel state of the backhaul downlink subframe.
